(19) United States
(12) Patent Application Publication
(10) Pub. No.: US 2017/0257785 A1
(43) Pub. Date: Sep. 7, 2017

(54) Determining Measurement Gap Patterns

(71) Applicant: Nokia Solutions and Networks Oy, Espoo (FI)

(72) Inventors: Tero Henttonen, Espoo (FI); Timo Erkki Lunttila, Espoo (FI); Benoist Pierre Sebire, Tokyo (JP)

(21) Appl. No.: 15/327,156

(22) PCT Filed: Aug. 8, 2014
(86) PCT No.: PCT/EP2014/067054

§ 371 Date: Jan. 18, 2017

(51) Int. Cl. H04W 24/10; H04W 72/04; H04L 5/00

(52) U.S. Cl. CPC H04W 24/10; H04L 5/0048; H04W 72/042; H04W 72/0413

(57) ABSTRACT

Determining measurement gap patterns A terminal device acquires (200), from a network node, a message indicating a discovery reference signal DRS measurement timing configuration for the terminal device for measuring discovery reference signals, and at least one measurement gap pattern MGP. The terminal device determines (206) an effective measurement gap pattern EMGP based on the at least one measurement gap pattern MGP and the DRS measurement timing configuration. (FIG. 2)

### TECHNICAL FIELD

The invention relates to the field of cellular communication systems and, particularly, determining a measurement gap pattern for a terminal device.

### BACKGROUND

A communication system may be seen as a facility that enables communication sessions between two or more nodes such as fixed or mobile communication devices, access points such as nodes, base stations, servers, hosts, machine type servers, routers, and so on. A communication system and compatible communicating devices typically operate in accordance with a given standard or specification which sets out what the various entities associated with the system are permitted to do and how that should be achieved. For example, the standards, specifications and related protocols may define the manner how communication devices communicate with the access points, how various aspects of the communications are implemented and how the devices and functionalities thereof are configured.

An example of cellular communication systems is an architecture that is being standardized by the 3rd generation partnership project (3GPP). A recent development in this field is often referred to as the long-term evolution (LTE) or long-term evolution advanced (LTE advanced) of the universal mobile telecommunications system (UMTS) radio-access technology. In LTE, base stations providing the cells are commonly referred to as enhanced node-Bs (eNB). eNBs may provide coverage for an entire cell or similar radio service area.

### BRIEF DESCRIPTION

The invention is defined by the independent claims.

Embodiments are defined in the dependent claims.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of preferred embodiments with reference to the attached drawings, in which

FIG. 1 is illustrates a wireless communication system to which embodiments of the invention may be applied;

FIG. 2 illustrates a signalling diagram of a procedure for managing discovery reference signals measurement according to an embodiment of the invention;

FIGS. 3, 4 and 5 illustrate effective measurement gap patterns according to some embodiments of the invention;

FIGS. 6 and 7 illustrate processes for managing discovery reference signals measurement according to some embodiments of the invention;

FIGS. 8 and 9 illustrate blocks diagrams of apparatuses according to some embodiments of the invention.

### DETAILED DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

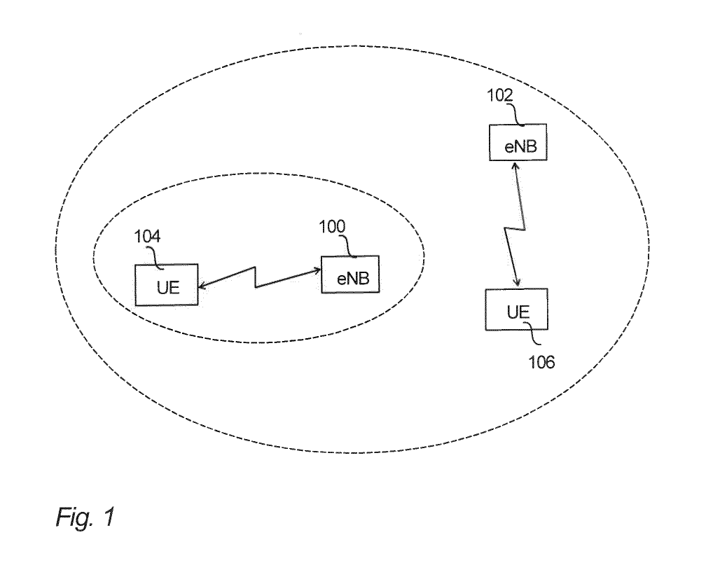

FIG. 1 illustrates a wireless communication scenario to which embodiments of the invention may be applied. Referring to FIG. 1, a cellular communication system may comprise a radio access network comprising base stations disposed to provide radio coverage in a determined geographical area. The base stations may comprise macro cell base stations 102 arranged to provide terminal devices 104, 106 with the radio coverage over a relatively large area spanning even over several square miles, for example. In densely populated hotspots where improved capacity is required, small area cell base stations 100 may be deployed to provide terminal devices 104 with high data rate services. Such small area cell base stations may be called micro cell base stations, pico cell base stations, or femto cell base stations. The small area cell base stations typically have significantly smaller coverage area than the macro base stations 102. The cellular communication system may operate according to specifications of the 3rd generation partnership project (3GPP) long term evolution (LTE) advanced or its evolution version.

Regarding physical-layer aspects of small cell enhancement, small cell on/off operation facilitates on/off switching of small cells e.g. to reduce network energy consumption as well as interference during the times when the network load is low. This may require the use of a discovery procedure such as discovery signals (e.g. discovery reference signals DRS). Cells operating a cell on/off switching may transmit discovery signal(s) supporting at least cell identification, coarse time/frequency synchronization, intra/inter-frequency radio resource management (RRM) measurement of cells and possibly antenna quasi-co-location QCL. This includes support of discovery and measurement enhancement(s) in downlink and its usage in related procedures.

In a connected mode, measurement gaps allow a terminal device to tune its receiver to another frequency or another radio access technology (RAT) to perform measurements. During a measurement gap, there is no downlink or uplink activity from/in a serving cell for the terminal device. In LTE system, the measurement gaps are configured by radio resource control (RRC) protocol and they occur e.g. with a periodicity of 40 ms or 80 ms and last e.g. for 6 ms in downlink and 7 ms in uplink. Thus, the measurement gaps are used in LTE for providing the terminal devices with possibilities to perform cell search and RRM measurements for other carriers. During the measurement gap, the terminal device is not expected to receive data from its serving cell. In order to avoid the whole cell from becoming unused during the measurement gaps, the network may configure the measurement gaps of the terminal devices over time.

Cell-specific reference signals (CRS) may be transmitted continuously in every downlink sub-frame. Furthermore, primary and secondary synchronization signals (PSS/SSS) may occur in every 5th sub-frame. Therefore, the network is able to configure measurement gaps flexibly. The network may configure a measurement gap for a given terminal to occur at any point of time, knowing that the signals required for RRM measurements (i.e. PSS/SSS/CRS) always coincide with any 6 ms period.

Discovery reference signals (DRS) facilitate the discovery of dormant cells/base station, and/or support transmission point identification. The discovery reference signals may be used as reference signals for both cell search and RRM measurements. A DRS occasion has a duration of one or more sub-frames and comprises PSS/SSS/CRS and possibly (if configured) channel state information reference signals (CSI-RS). The DRS occasions are transmitted by the base station with a periodicity of a few tens or hundreds of milliseconds. It has been agreed that DRS may only be transmitted on a downlink sub-frame or DwPTS region of sub-frames. For a DRS-based measurement, the terminal device assumes that 1) the DRS occasion for a cell contains one instance of PSS/SSS per Rel-8, 2) CRS is transmitted at least in the same sub-frame(s) as PSS/SSS, 3) the DRS occasion may comprise multiple CSI-RS resource element (RE) configurations, wherein the different CSI-RS configurations may be in the same or different sub-frame(s), and/or the different CSI-RS configurations may be scrambled independently, 4) the DRS occasion may comprise relative sub-frame offset between SSS and one CSI-RS RE configuration, possibly between variable or fixed within 5 ms relative to sub-frame of SSS. Further, the terminal device assumes that the DRS occasion for the cell comprises N consecutive sub-frames (N<=5). Yet further, the terminal device assumes that the DRS occasion for the cell is transmitted every M ms, wherein candidate values for M include 40, 80, 160, and possibly other values. RAN1 design does not assume any requirements for the number of detectable cells using DRS.

It has further been agreed that regarding DRS based measurements, the terminal device may be configured with one DRS measurement timing configuration (DMTC) per frequency, wherein the reference timing for the offset is the primary serving cell's timing. No new measurement gap pattern is introduced in LTE Rel-12 for DRS-based measurement. For the purpose of DRS based measurements, the terminal device assumes only the presence of DRS signals. For both intra- and inter-frequency measurement, if the terminal device is configured with only DRS-based measurements reporting on a given carrier frequency, and the terminal device is not configured with an activated serving cell on that carrier frequency, the terminal device should not assume the presence of any signal and channel except for DRS in the DMTC (DRS measurement timing configuration) duration.

The relatively large periodicity of DRS transmissions creates a problem with respect to the measurement gaps. The agreed measurement gap configuration (“no new measurement gap pattern is introduced for the DRS-based measurement”) and the agreed set of candidate values for the periodicity of the DRS occasions (“candidate values for M are 40, 80, 160, possibly other values”) may lead into a situation where each of the terminal devices (or at least a large number of them) perform their DRS-based RRM measurements at the same times, making it hard for the network to find terminal devices to be scheduled during the measurement gaps. This results in a loss of system throughput.

The terminal device and/or the base station may be allowed to identify that which of the cells (that the terminal device has detected and measured) are dormant from the measurement reports alone.

The DRS periodicity may be a multiple of 40 ms and align each measurement gap of each terminal device to match the occurrence of DRS. However, aligning each measurement gap of each terminal device creates a window during which no terminal device measuring the ON/OFF cells can be scheduled, thus reducing the maximum throughput that the serving cell is able to offer. Further, the ON/OFF cells need to be synchronised to match the measurement gap opportunities.

Modern cellular communication systems are wideband systems where a large bandwidth may be scheduled to a single terminal device for the transmission of data. The scheduled resources may be indicated in terms of physical resource blocks or frequency resource blocks. Each frequency resource block has a determined bandwidth and a centre frequency and one or more frequency resource blocks may be scheduled to the terminal device at a time. The frequency resource blocks scheduled to the terminal device may be contiguous and, thus, form a continuous scheduled band for the terminal device. However, the resource blocks may be non-contiguous in which case the form a non-contiguous band fragmented into a plurality of smaller bands.

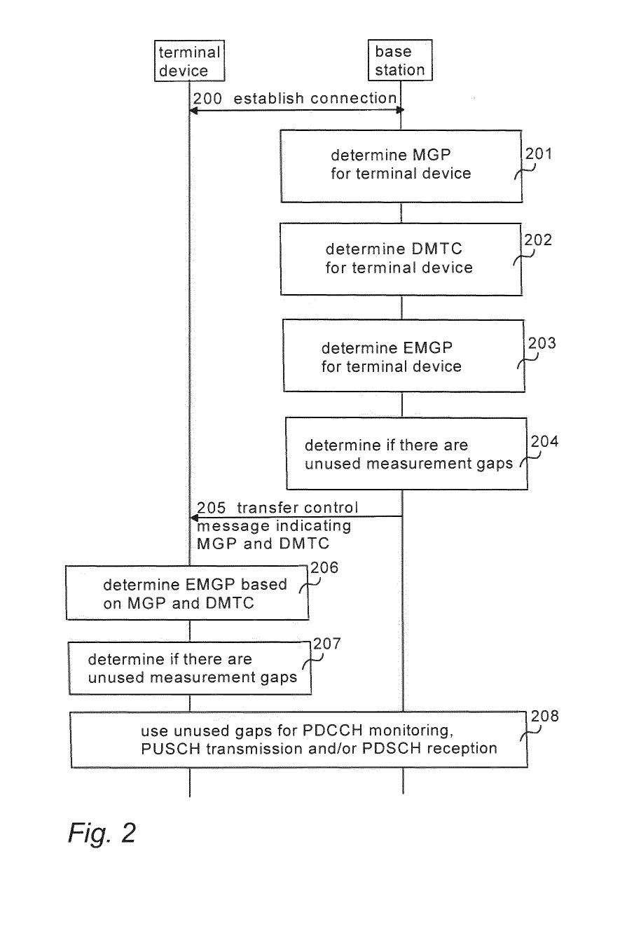

Let us now describe an embodiment of the invention for selecting and signalling measurement gap pattern parameters with reference to FIG. 2. FIG. 2 illustrates a signalling diagram illustrating a method for signalling measurement gap pattern parameters between a base station of a cellular communication system, e.g. base station 100 or 102, and a terminal device of the cellular communication system, e.g. the terminal device 104 or 106. In another embodiment, the procedure of FIG. 2 may be carried out between the terminal device and an access node or, more generally, a network node. The network node may be a server computer or a host computer. For example, the server computer or the host computer may generate a virtual network through which the host computer communicates with the terminal device. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer. External network virtualization is targeted to optimized network sharing. Another category is internal virtual networking which provides network-like functionality to the software containers on a single system. Virtual networking may also be used for testing the terminal device.

Referring to FIG. 2, a communication link is established between the base station and the terminal device (step 200). Step 200 may comprise establishment of a control channel connection. The control channel connection may comprise a radio resource control (RRC) connection. In block 201, the base station determines, at least one measurement gap pattern for the terminal device. In block 202, the base station determines, for the terminal device, a DRS measurement timing configuration for measuring discovery reference signals. In block 203, the base station determines, for the terminal device, an effective measurement gap pattern (EMGP), based on the measurement gap pattern and the DRS measurement timing configuration. The order in which DMTC and MGP are configured is not relevant, either may be configured first. MGP may be configured first, but just as well the terminal device may be first configured for the DRS measurements, and after that MGP may be decided based on what the resulting EMGP may look like. In block 204, the base station determines whether there are unused (i.e. free/available) measurement gaps that are usable for normal scheduling of PUSCH/PDSCH/PDCCH/PUCCH data. In step 205, the base station transmits a control message to the terminal device. The control message comprises at least one information element indicating an RRC configuration for the terminal device, comprising the measurement gap pattern and the DRS measurement timing configuration. The terminal device acquires the control message from the base station in step 205 and stores the information on the measurement gap pattern and the DRS measurement timing configuration. MGP and DMTC may also be transmitted independently of each other. For example, the terminal device may have MGP for other purposes, and the base station may then decide to activate DMTC. The information may be used in connection with transferring data with the base station, as described next. In block 206, the terminal device determines an implicit or an explicit effective measurement gap pattern based on the at least one measurement gap pattern and the DRS measurement timing configuration. In block 207, the terminal device determines whether there are unused measurement gaps, and, if there are, the terminal device uses (block 208) those for one or more of PDCCH monitoring, PUCCH transmission, PUSCH transmission, and PDSCH reception.

Small cell ON/OFF switching and related discovery procedures are hereby enhanced by defining how discovery reference symbols (DRS) work together with existing measurement gaps. It is defined how the terminal device measures the ON/OFF cells operating on inter-frequencies, and it is ensured that each terminal device in the cell does not perform the inter-frequency measurement at the same time. The network is thus able to determine and reuse some gaps assigned to the terminal device. The network is able to configure measurement gaps at different times for different terminals, allowing better scheduling efficiency. A different DRS timing is also allowed for different cells on a frequency, or different cells in different frequencies.

In an embodiment, the terminal device performs, at time instances defined in the effective measurement gap pattern, at least one of intra- and inter-frequency measurements.

In an embodiment, the terminal device determines carrier-specific effective measurement gap patterns based on the measurement gaps and the DRS measurement timing configuration such that only those measurement gaps that coincide with the DRS measurement timing configuration of the carrier are included into the carrier-specific effective measurement gap patterns.

In an embodiment, the terminal device determines, based on the carrier-specific effective measurement gap patterns, a combined effective measurement gap pattern indicating which measurement gaps are used in any of measured carriers.

In an embodiment, the terminal device determines, based on the measurement gaps and the combined effective measurement gap pattern, which measurement gaps are not needed, and utilizes those measurement gaps for reception and/or transmission.

In an embodiment, the terminal device monitors its serving cell during the measurement gaps that are not needed.

In an embodiment, the terminal device determines EMGP based on the measurement gap pattern and an explicit indication of a DRS occasion transmission configuration.

In an embodiment, the terminal may perform inter-frequency measurements on a given carrier only when EMGP indicates so, i.e. when the measurement gap pattern and the measurement occasion pattern overlap. To allow the network to configure different terminal devices with different patterns, periodicities of the measurement gap pattern and the measurement occasion pattern are supposed not to be multiples of each other.

In an embodiment, the indication of EMGP may be implicit or explicit. An implicit indication may be accomplished by e.g. a fixed value (e.g. 30 or 50 ms) for DMTC or by the terminal device calculating EMGP based on a signalled DRS periodicity value. An explicit indication may be accomplished by e.g. explicitly indicating the DMTC pattern to be used or by indicating the unused gaps explicitly.

In an embodiment, EMGP is applied only to intra-frequency measurements, only to inter-frequency measurements, or to both types of measurements.

In an embodiment, measurement gaps (only) apply to inter-frequency measurements for ON/OFF cells with EMGP. In an embodiment, measurement gaps also apply to intra-frequency measurements in order to guarantee that the terminal device is grabbing at least as many samples for intra-frequency measurements of ON/OFF-cells as for inter-frequency measurements and that the terminal device does not look around without being able to measure anything due to DRS not being transmitted.

In an embodiment, s-measure (i.e. the terminal device not being allowed to perform measurements when the measured quality of the serving cell is good over an indicated threshold) may not apply to ON/OFF cells measured with EMGP. This means that indicating EMGP also indicates disregarding the s-measure for the DRS measurements. Alternatively, a separate s-measure may be signalled for the ON/OFF measurements during EMGP but even in this case the normal s-measure may not apply for the ON/OFF-cells.

In an embodiment, L1/L3 filtering of measurements for ON/OFF cells measured with EMGP may be different from normal RRM measurements, i.e. the indication of EMGP also indicates the used L1/L3 filtering (implicitly or explicitly).

In an embodiment, EMGP is cell-specific within a carrier, indicating that some cells may only be measured at some EMGP occasions. This allows the network more freedom when configuring the DRS transmission occasions for different cells, e.g. for interference coordination purposes.

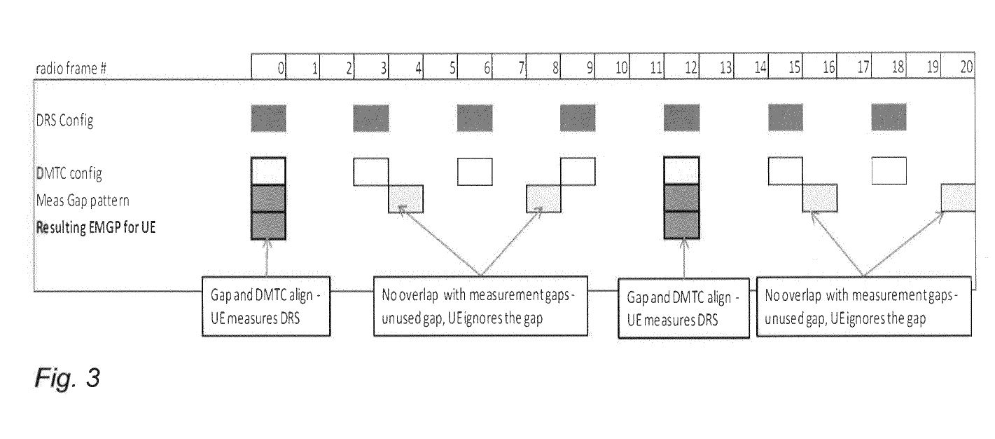

In an embodiment, with EMGP the ON/OFF cells are configured with a DRS periodicity that is not the periodicity of the terminal device measurement gaps in order to introduce effective measurement gaps that coincide with DRS. I.e. to guarantee that even without synchronisation, DRS and the measurement gap coincide after a fixed number of measurement gap occurrences. For instance, with a DRS periodicity of 30 ms and a measurement gap periodicity of 40 ms, DRS coincides with the measurement gap every 120 ms. For a single terminal device, this may be accomplished e.g. with a DMTC periodicity of 30 ms as illustrated in FIG. 3.

FIG. 3 illustrates the effective measurement gap pattern EMGP from a single terminal device's perspective, highlighting how DMTC and measurement gaps create the EMGP pattern (EMGP—UE perspective: DRS/DMTC periodicity=30 ms, gap pattern=40 ms).

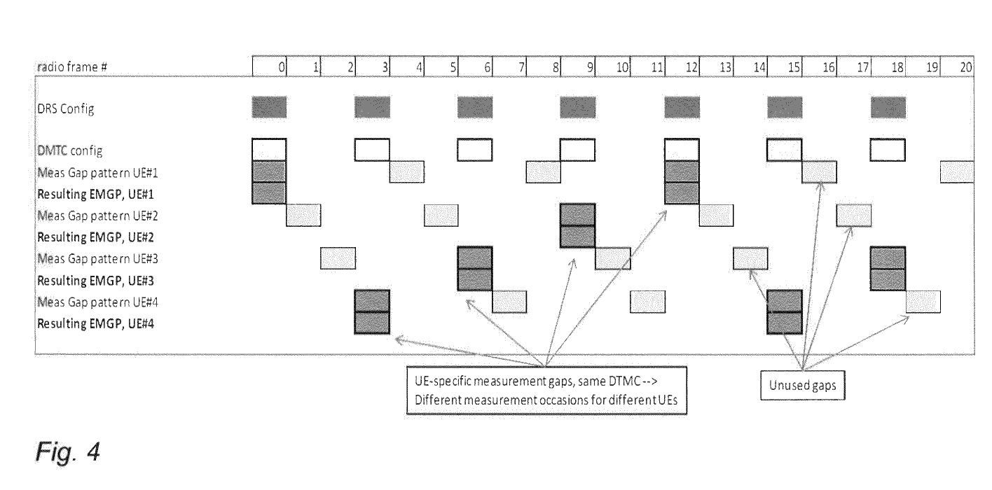

FIG. 4 illustrates the network perspective, showing how network may configure different terminal devices with different measurement gap starting occasions despite of the same DRS configuration in the carrier (EMGP—network perspective (DRS/DMTC periodicity=30 ms, gap pattern=40 ms).

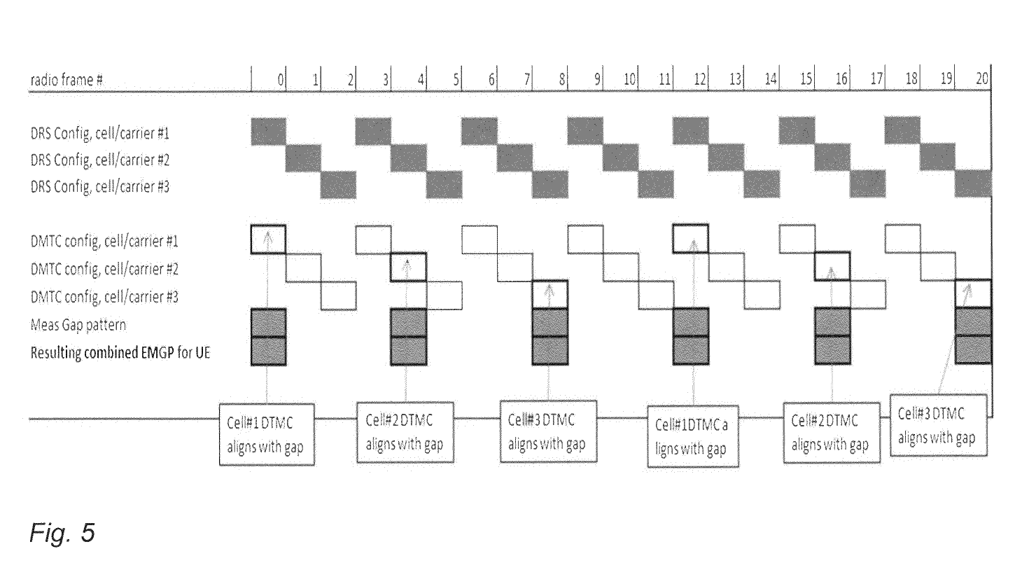

FIG. 5 illustrates how EMGP may end up being the same as a legacy gap pattern but with different gaps used for different carriers/cells (combined EMGP for a single UE: cell/carrier-specific DMTC configuration).

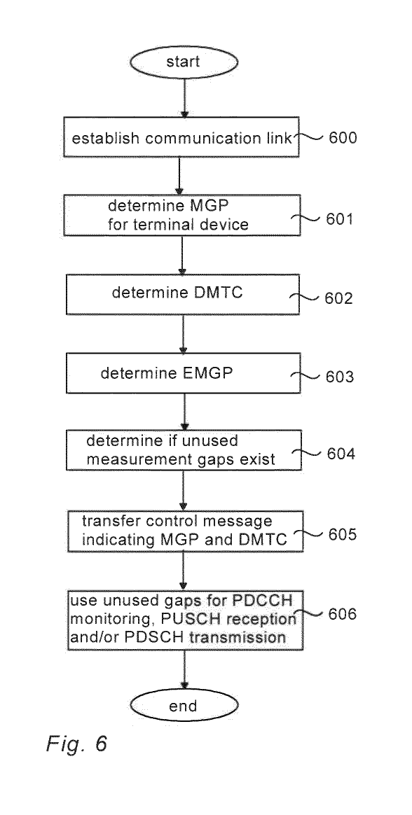

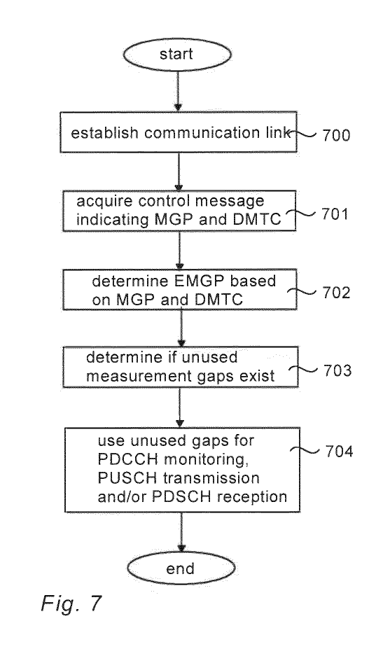

Let us now describe some embodiments with reference to FIGS. 6 and 7.

Referring to FIG. 6, the base station may establish a communication link with the terminal device (step 600). Step 600 may comprise establishment of a control channel connection. The control channel connection may comprise a radio resource control (RRC) connection. In block 601, the base station determines, at least one measurement gap pattern for the terminal device. In block 602, the base station determines, for the terminal device, a DRS measurement timing configuration for measuring discovery reference signals. In block 603, the base station determines for the terminal device, based on the measurement gap pattern and the DRS measurement timing configuration for measuring discovery reference signals, an effective measurement gap pattern (EMGP). In block 604, the base station determines whether there are unused (i.e. free/available, not used for DRS measurements) measurement gaps that are usable for normal scheduling of PUSCH/PDSCH/PDCCH/PUCCH data. In block 605, the base station transmits a control message to the terminal device. The control message comprises at least one information element indicating an RRC configuration for the terminal device, comprising the measurement gap pattern and the DRS measurement timing configuration. If there are unused measurement gaps, they may be used (block 606) for one or more of PDCCH monitoring, PDCCH transmission, PDSCH transmission, and PUSCH reception.

Referring to FIG. 7, the terminal device may establish a communication link with the base station (step 700). Step 700 may comprise establishment of a control channel connection. The control channel connection may comprise a radio resource control (RRC) connection. In block 701, the terminal device acquires a control message from the base station. The control message comprises at least one information element indicating an RRC configuration for the terminal device, comprising the measurement gap pattern and the DRS measurement timing configuration. The terminal device may store the information on the measurement gap pattern and the DRS measurement timing configuration. The information may be used in connection with transferring data with the base station, as described next. In block 702, the terminal device determines an implicit or an explicit effective measurement gap pattern based on the at least one measurement gap pattern and the DRS measurement timing configuration. In block 703, the terminal device determines whether there are unused measurement gaps, and, if there are, the terminal device uses (block 704) those for one or more of PDCCH monitoring, PUCCH transmission, PUSCH transmission, and PDSCH reception.

In an embodiment, the embodiments of FIGS. 6 and 7 may be combined. In a modification, the processes of FIGS. 6 and/or 7 may be exclusive to small area cell base stations, e.g. the base station 100 may carry out the embodiments of FIG. 2, 6, and/or 7 but the macro base station 102 may not.

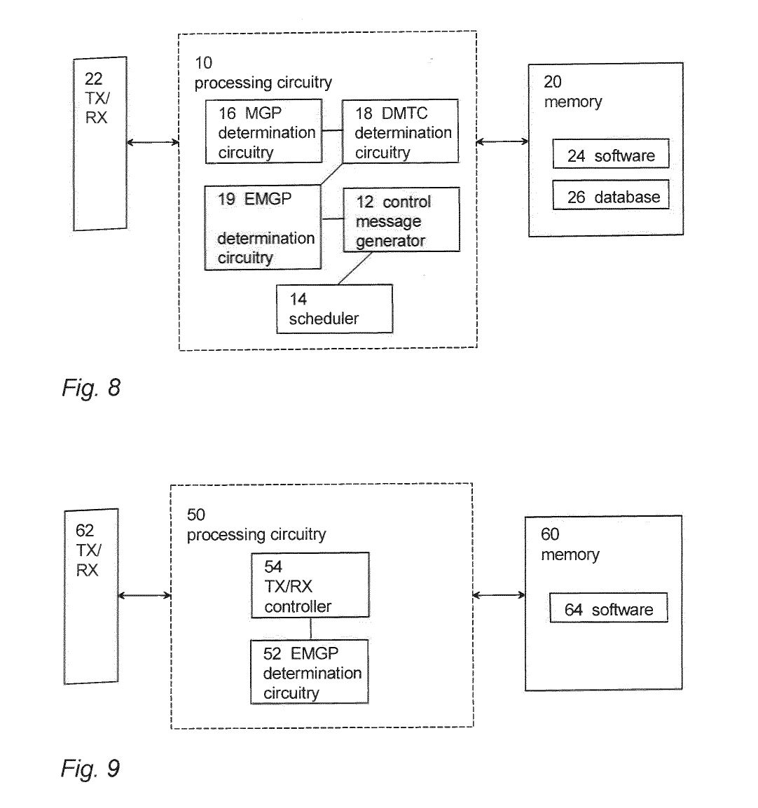

An embodiment provides an apparatus comprising at least one processor and at least one memory including a computer program code, wherein the at least one memory and the computer program code are configured, with the at least one processor, to cause the apparatus to carry out the procedures of the above-described base station or the network node. The at least one processor, the at least one memory, and the computer program code may thus be considered as an embodiment of means for executing the above-described procedures of the base station or the network node. FIG. 8 illustrates a block diagram of a structure of such an apparatus. The apparatus may be comprised in the base station or the network node, e.g. the apparatus may form a chipset or a circuitry in the base station or the network node. In some embodiments, the apparatus is the base station or the network node. The apparatus comprises a processing circuitry 10 comprising the at least one processor. The processing circuitry 10 may comprise an MGP determination circuitry 16 configured to determine, at least one measurement gap pattern for the terminal device. A DMTC determination circuitry 18 may be configured to determine for the terminal device a DRS measurement timing configuration for measuring discovery reference signals. An EMGP determination circuitry 19 may be configured to determine, for the terminal device, an effective measurement gap pattern (EMGP) based on the measurement gap pattern and the DRS measurement timing configuration for measuring discovery reference signals. Upon determining the DRS measurement timing configuration, the DMTC determination circuitry 19 may output a signal indicating the determined DMTC and MGP to a control message generator 12 configured to generate the control message indicating the determined DMTC and MGP to the terminal device for which DMTC and MGP are determined.

The apparatus may further comprise a scheduler circuitry 14 configured to schedule frequency resource blocks in transmission time intervals to the terminal devices. The scheduler circuitry 14 may output to the control message generator information on the schedulings and the control message generator 12 may create the scheduling messages indicating the schedulings to the terminal devices on a control channel.

The processing circuitry 10 may comprise the circuitries 12 to 19 as sub-circuitries, or they may be considered as computer program modules executed by the same physical processing circuitry. The memory 20 may store one or more computer program products 24 comprising program instructions that specify the operation of the circuitries 12 to 19. The memory 20 may further store a database comprising definitions for the selection of the link adaptation scheme, for example. The apparatus may further comprise a communication interface 22 providing the apparatus with radio communication capability with the terminal devices. The communication interface 22 may comprise a radio communication circuitry enabling wireless communications and comprise a radio frequency signal processing circuitry and a baseband signal processing circuitry. The baseband signal processing circuitry may be configured to carry out the functions of the transmitter and/or the receiver, as described above in connection with FIGS. 1 to 7. In some embodiments, the communication interface may be connected to a remote radio head comprising at least an antenna and, in some embodiments, radio frequency signal processing in a remote location with respect to the base station. In such embodiments, the communication interface 22 may carry out only some of radio frequency signal processing or no radio frequency signal processing at all. The connection between the communication interface 22 and the remote radio head may be an analogue connection or a digital connection.

An embodiment provides another apparatus comprising at least one processor and at least one memory including a computer program code, wherein the at least one memory and the computer program code are configured, with the at least one processor, to cause the apparatus to carry out the procedures of the above-described terminal device. The at least one processor, the at least one memory, and the computer program code may thus be considered as an embodiment of means for executing the above-described procedures of the terminal device. FIG. 9 illustrates a block diagram of a structure of such an apparatus. The apparatus may be comprised in the terminal device, e.g. it may form a chipset or a circuitry in the terminal device. In some embodiments, the apparatus is the terminal device. The apparatus comprises a processing circuitry 50 comprising the at least one processor. The processing circuitry 50 may comprise a communication controller circuitry 54 configured to extract control messages received from a serving base station, to acquire the measurement gap pattern and the DRS measurement timing configuration determined for the terminal device, and to control the terminal device to transmit or receive data between the base station in the scheduled communication resources. The apparatus may further comprise an EMGP determination circuitry 52 configured to determine an implicit or an explicit effective measurement gap pattern based on the at least one measurement gap pattern and the DRS measurement timing configuration.

The processing circuitry 50 may comprise the circuitries 52, 54 as sub-circuitries, or they may be considered as computer program modules executed by the same physical processing circuitry. The memory 60 may store one or more computer program products 64 comprising program instructions that specify the operation of the circuitries 52, 54. The apparatus may further comprise a communication interface 62 providing the apparatus with radio communication capability with base stations of one or more cellular communication networks. The communication interface 62 may comprise a radio communication circuitry enabling wireless communications and comprise a radio frequency signal processing circuitry and a baseband signal processing circuitry. The baseband signal processing circuitry may be configured to carry out the functions of the transmitter and/or the receiver, as described above in connection with FIGS. 1 to 8.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described above in connection with FIGS. 1 to 9 may also be carried out in the form of one or more computer process defined by one or more computer programs. The computer program shall be considered to encompass also a module of a computer programs, e.g. the above-described processes may be carried out as a program module of a larger algorithm or a computer process. The computer program(s) may be in source code form, object code form, or in some intermediate form, and it may be stored in a carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to cellular or mobile communication systems defined above but also to other suitable communication systems. The protocols used, the specifications of cellular communication systems, their network elements, and terminal devices develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

### LIST OF ABBREVIATIONS

3GPP third generation partnership program

CRS cell-specific reference signals

CSI-RS channel state information reference signal

DCI downlink control information

DL downlink

DMTC DRS measurement timing configuration

DRS discovery reference signals

EMGP effective measurement gap pattern

eNB base station

LTE long term evolution

MBSFN multimedia broadcast multicast service single frequency network

PSS primary synchronisation signal

RAN radio access network

RAT radio access technology

Rel release

RRM radio resource management

SSS secondary synchronisation signal

UE user equipment

1-19. (canceled)

20. A method comprising: acquiring, in a terminal device of a cellular communication system, a control message from a network node, the control message comprising at least one information element indicating at least one discovery reference signal (DRS) measurement timing configuration for the terminal device for measuring discovery reference signals and at least one measurement gap pattern; determining, in the terminal device, an effective measurement gap pattern based on the at least one measurement gap pattern and the at least one DRS measurement timing configuration.

21. The method of claim 20, further comprising in the terminal device:
determining whether there are measurement gaps that are not used for DRS measurements or other measurements, and, if there are, using those measurement gaps for one or more of PDCCH monitoring, PUCCH transmission, PUSCH transmission, and PDSCH reception.

22. The method of claim 20, further comprising in the terminal device: at time instances defined in the effective measurement gap pattern, performing at least one of intra- and inter-frequency measurements.

23. The method of claim 20, comprising in the terminal device: determining carrier-specific effective measurement gap patterns based on the measurement gaps and the DRS measurement timing configuration such that only those measurement gaps that coincide with the DRS measurement timing configuration of the carrier are included into the carrier-specific effective measurement gap patterns.

24. The method of claim 23, further comprising in the terminal device: based on the carrier-specific effective measurement gap patterns, determining a combined effective measurement gap pattern indicating which measurement gaps are used in any of measured carriers.

25. The method of claim 20, further comprising in the terminal device:
monitoring its serving cell during measurement gaps that are not used for DRS measurements or other measurements.

26. The method of claim 20, comprising in the terminal device: determining the effective measurement gap pattern based on the measurement gap pattern and an explicit indication of a DRS occasion transmission configuration.

27. A method comprising: determining, in a network node, at least one measurement gap pattern for a terminal device of a cellular communication system; determining, in the network node for the terminal device, a DRS measurement timing configuration for measuring discovery reference signals; causing, in the network node, transmission of a control message to the terminal device, the control message comprising at least one information element indicating an RRC configuration for the terminal device, comprising the measurement gap pattern and the DRS measurement timing configuration.

28. The method of claim 27, further comprising in the network node: determining for the terminal device, an effective measurement gap pattern, based on the measurement gap pattern and the DRS measurement timing configuration for measuring discovery reference signals; and determining whether there are unused measurement gaps that are usable for normal scheduling of at least one of PUSCH data, PDSCH data, PDCCH data, and PUCCH data.

29. The method of claim 27, further comprising: configuring cells with a DRS periodicity other than a measurement gap periodicity of 40 or 80 ms, to obtain effective measurement gaps that coincide with the DRS periodicity such that DRS timing and the measurement gap coincide after a fixed number of measurement gap occurrences.

30. An apparatus comprising: at least one processor; and at least one memory including a computer program code, wherein the at least one memory and the computer program code are configured, with the at least one processor, to cause the apparatus to: acquire, a control message from a network node, the control message comprising at least one information element indicating at least one DRS measurement timing configuration for a terminal device of a cellular communication system, for measuring discovery reference signals and at least one measurement gap pattern; determine, an effective measurement gap pattern based on the at least one measurement gap pattern and the at least one DRS measurement timing configuration.

31. The apparatus of claim 30, wherein the at least one memory and the computer program code are configured, with the at least one processor, to cause the apparatus to: determine whether there are measurement gaps that are not used for DRS measurements or other measurements, and, if there are, use those measurement gaps for one or more of PDCCH monitoring, PUCCH transmission, PUSCH transmission, and PDSCH reception.

32. The apparatus of claim 30, wherein the at least one memory and the computer program code are configured, with the at least one processor, to cause the apparatus to: at time instances defined in the effective measurement gap pattern, perform at least one of intra- and inter-frequency measurements.

33. The apparatus of claim 30, wherein the at least one memory and the computer program code are configured, with the at least one processor, to cause the apparatus to: determine carrier-specific effective measurement gap patterns based on the measurement gaps and the DRS measurement timing configuration such that only those measurement gaps that coincide with the DRS measurement timing configuration of the carrier are included into the carrier-specific effective measurement gap patterns.

34. The apparatus of claim 30, wherein the at least one memory and the computer program code are configured, with the at least one processor, to cause the apparatus to: based on the carrier-specific effective measurement gap patterns, determine a combined effective measurement gap pattern indicating which measurement gaps are used in any of measured carriers.

35. The apparatus of claim 30, wherein the at least one memory and the computer program code are configured, with the at least one processor, to cause the apparatus to: monitor its serving cell during measurement gaps that are not used for DRS measurements or other measurements.

36. The apparatus of claim 30, wherein the at least one memory and the computer program code are configured, with the at least one processor, to cause the apparatus to: determine the effective measurement gap pattern based on the measurement gap pattern and an explicit indication of a DRS occasion transmission configuration.

37. An apparatus comprising: at least one processor; and at least one memory including a computer program code, wherein the at least one memory and the computer program code are configured, with the at least one processor, to cause the apparatus to: determine at least one measurement gap pattern for a terminal device of a cellular communication system; determine, for the terminal device, a DRS measurement timing configuration for measuring discovery reference signals; determine, whether there are unused measurement gaps that are usable for normal scheduling of at least one of PUSCH data, PDSCH data, PDCCH, data, and PUCCH data; and cause, transmission of a control message to the terminal device, the control message comprising at least one information element indicating an RRC configuration for the terminal device, comprising the measurement gap pattern and the DRS measurement timing configuration.

38. The apparatus of claim 37, wherein the at least one memory and the computer program code are configured, with the at least one processor, to cause the apparatus to: determine, for the terminal device, an effective measurement gap pattern, based on the measurement gap pattern and the DRS measurement timing configuration for measuring discovery reference signals; and determine, whether there are unused measurement gaps that are usable for normal scheduling of at least one of PUSCH data, PDSCH data, PDCCH data, and PUCCH data.

39. The apparatus of claim 37, wherein the at least one memory and the computer program code are configured, with the at least one processor, to cause the apparatus to: configure cells with a DRS periodicity other than a measurement gap periodicity of 40 or 80 ms, to obtain effective measurement gaps that coincide with the DRS periodicity such that DRS timing and the measurement gap coincide after a fixed number of measurement gap occurrences.

40. A computer program product comprising a computer readable medium bearing computer program code for acquiring, in a terminal device of a cellular communication system, a control message from a network node, the control message comprising at least one information element indicating at least one discovery reference signal (DRS) measurement timing configuration for the terminal device for measuring discovery reference signals and at least one measurement gap pattern; determining, in the terminal device, an effective measurement gap pattern based on the at least one measurement gap pattern and the at least one DRS measurement timing configuration.

41. A computer program product comprising a computer readable medium bearing computer program code for determining, in a network node, at least one measurement gap pattern for a terminal device of a cellular communication system; determining, in the network node for the terminal device, a DRS measurement timing configuration for measuring discovery reference signals; and causing, in the network node, transmission of a control message to the terminal device, the control message comprising at least one information element indicating an RRC configuration for the terminal device, comprising the measurement gap pattern and the DRS measurement timing configuration.
